(19) United States
(12) Patent Application Publication
(10) Pub. No.: US 2017/0262453 A1
(43) Pub. Date: Sep. 14, 2017

(54) SYSTEM AND METHOD FOR DETERMINING DRIVING DECISIONS BASED ON MULTIMEDIA CONTENT

(71) Applicant: Cortica, Ltd., TEL AVIV (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/601,440

(22) Filed: May 22, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/339,827, filed on May 21, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for determining driving decisions based on multimedia content. The method includes obtaining, in real-time during a trip of a vehicle, trip multimedia content elements captured by at least one sensor deployed in proximity to the vehicle; identifying, based on at least one signature generated for each trip multimedia content element, at least one matching event multimedia content element, wherein each event multimedia content element demonstrates an event and is associated with a corresponding driving decision; and determining, in real-time, at least one driving decision, wherein each determined driving decision is associated with one of the identified at least one event multimedia content element.

### CROSS-REFERENCE TO RELATED APPLICATIONS

This application claims the benefit of U.S. Provisional Application No. 62/339,827 filed on May 21, 2016. This application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to autonomous driving, and more particularly to generating autonomous or assisted driving decisions based on analysis of multimedia content.

### BACKGROUND

In part due to improvements in computer processing power and in location-based tracking systems such as global positioning systems, automated and other assisted driving systems have been developed with the aim of providing driverless control or driver-assisted control of vehicles during transportation. An autonomous vehicle includes a system for controlling the vehicle based on the surrounding environment such that the vehicle autonomously controls functions such as accelerating, braking, steering, and the like.

Existing solutions for automated driving may use a global positioning system receiver, electronic maps, and the like, to determine a path from one location to another. Fatalities and injuries due to vehicles colliding with people or obstacles during the determined path are significant concerns for developers of autonomous driving systems. To this end, automated driving systems may utilize sensors such as cameras and radar for detecting objects to be avoided. However, not all vehicles in the near future will be autonomous, and even among autonomous vehicles, additional safety precautions are warranted. Further, some existing automated solutions face challenges in avoiding dangerous circumstances, particularly when the presence or absence of obstacles and other events requiring altering driving varies between trips.

It would be therefore advantageous to provide a solution for accurately recommending tags that matches the multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for providing driving decisions based on multimedia content. The method comprises: obtaining, in real-time during a trip of a vehicle, trip multimedia content elements captured by at least one sensor deployed in proximity to the vehicle; identifying, based on at least one signature generated for each trip multimedia content element, at least one matching event multimedia content element, wherein each event multimedia content element demonstrates an event and is associated with a corresponding driving decision; and determining, in real-time, at least one driving decision, wherein each determined driving decision is associated with one of the identified at least one event multimedia content element.

Certain embodiments disclosed herein also include a non-transitory computer readable medium having stored thereon causing a processing circuitry to execute a process, the process comprising: obtaining, in real-time during a trip of a vehicle, trip multimedia content elements captured by at least one sensor deployed in proximity to the vehicle; identifying, based on at least one signature generated for each trip multimedia content element, at least one matching event multimedia content element, wherein each event multimedia content element demonstrates an event and is associated with a corresponding driving decision; and determining, in real-time, at least one driving decision, wherein each determined driving decision is associated with one of the identified at least one event multimedia content element.

Certain embodiments disclosed herein also include a system for providing driving decisions based on multimedia content. The system comprises: a processing circuitry; and a memory, the memory containing instructions that, when executed by the processing circuitry, configure the system to: obtain, in real-time during a trip of a vehicle, trip multimedia content elements captured by at least one sensor deployed in proximity to the vehicle; identify, based on at least one signature generated for each trip multimedia content element, at least one matching event multimedia content element, wherein each event multimedia content element demonstrates an event and is associated with a corresponding driving decision; and determine, in real-time, at least one driving decision, wherein each determined driving decision is associated with one of the identified at least one event multimedia content element.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a decision provider according to an embodiment.

FIG. 3 is a flowchart illustrating a method for determining driving decisions based on multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for determining driving decisions based on multimedia content elements. Multimedia content elements captured by at least one sensor deployed in proximity to a vehicle are obtained. Signatures are generated for the obtained multimedia content elements. The generated signatures are compared to a plurality of signatures representing multimedia content elements showing known driving events. Each known driving event multimedia content element is associated with a predetermined driving decision. Based on the comparison, at least one matching event multimedia content element is determined. At least one driving decision is determined based on the at least one matching event multimedia content element. The determined driving decisions may be sent to a driving control system configured in real-time such that the driving control system implements the determined driving decisions. New driving decisions are generated in real-time as new multimedia content elements are captured by the sensors of the vehicle, thereby allowing for at least partially autonomous control of the vehicle during a trip.

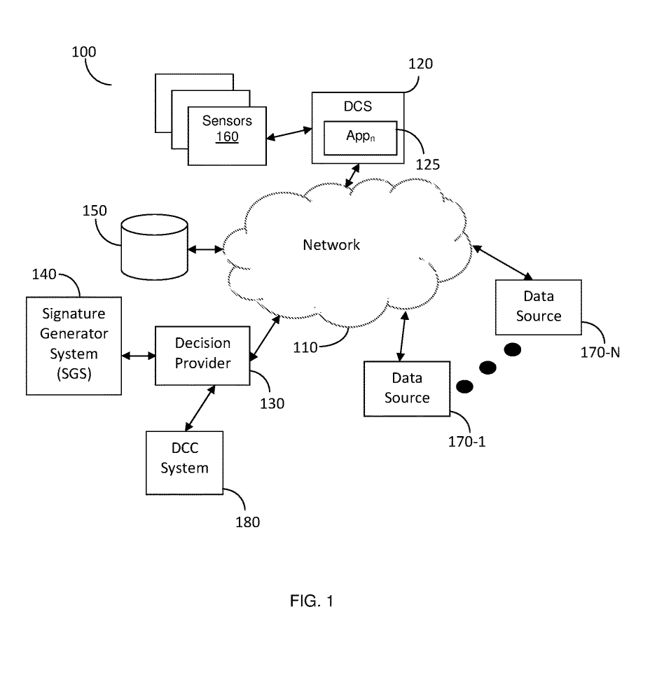

FIG. 1 is an example network diagram 100 utilized to describe the various embodiments disclosed. The network diagram 100 includes a driving control system 120, a decision provider 130, a database 150, at least one sensor 160, a plurality of data sources 170-1 through 170-m (hereinafter referred to individually as a data source 170 and collectively as data sources 170, merely for simplicity purposes), and a deep content classification (DCC) system 180, communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The driving control system 120 is configured to generate driving decisions in real-time during a trip of a vehicle (not shown) based on multimedia content elements captured by sensors 160 deployed in proximity to the vehicle. In an example implementation, the driving control system 120, the sensors 160, or both, may be disposed in or affixed to the vehicle. The trip includes movement of the vehicle from at least a start location to a destination location. During the trip, multimedia content elements are captured, where at least one of the captured multimedia content elements illustrates a driving event.

At least one of the sensors 160 is configured to capture multimedia content elements demonstrating characteristics of at least a portion of the environment (e.g., roads, obstacles, etc.) surrounding the vehicle. In an example implementation, the sensors 160 include a camera installed on, e.g., a dashboard of the vehicle, a hood of the vehicle, a rear window of the vehicle, and the like. The sensors 160 may further include a global positioning system (GPS) sensor for capturing GPS signals to be utilized in determining a location of the vehicle. The sensors 160 may be integrated in or communicatively connected to the driving control system 120 without departing from the scope of the disclosed embodiments.

The driving control system 120 may have installed thereon an application 125. The application 125 may be configured to send multimedia content elements captured by the sensors 160 to the decision provider 130, and to receive driving decisions from the decision provider 130. The application 125 may be further configured to receive user inputs (e.g., via an interface, not shown) indicating, for example, a beginning location pointer, a destination pointer, or both.

The database 150 may store a plurality of previously captured event multimedia content elements and associated driving decisions. Each event multimedia content element is a previously captured multimedia content element demonstrating a previously occurring event and is associated with a corresponding driving decision for controlling a vehicle to avoid, e.g., accidents, with respect to the event. The database 150 may further store an associated geographic location for one or more of the event multimedia content elements. Each associated geographic location may be, for example, a geographic location at which the associated event multimedia content element was captured.

In an example implementation, a signature generator system (SGS) 140 and a deep-content classification (DCC) system 180 are connected to the network 110 and may be utilized by the decision provider 130 to perform the various disclosed embodiments. Each of the SGS 140 and the DCC system 180 may be connected to the server 130 directly or through the network 110. In certain configurations, the SGS 140, the DCC system 180, or both may be embedded in the decision provider 130, or may be communicatively connected to the decision provider 1303 via the network 110.

The SGS 140 is configured to generate signatures to multimedia content elements and includes a plurality of computational cores, each computational core having properties that are at least partially statistically independent of each other core, where the properties of each core are set independently of the properties of each other core.

The deep content classification system 180 is configured to create, automatically and in an unsupervised fashion, concepts for a wide variety of multimedia content elements. To this end, the deep content classification system 180 may be configured to inter-match patterns between signatures for a plurality of multimedia content elements and to cluster the signatures based on the inter-matching. The deep content classification system 180 may be further configured to reduce the number of signatures in a cluster to a minimum that maintains matching and enables generalization to new multimedia content elements.

Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

In an embodiment, the decision provider 130 is configured to send the multimedia content element to be tagged to the signature generator system 140, to the deep content classification system 180, or both. In a further embodiment, the decision provider 130 is configured to receive a plurality of signatures generated to the multimedia content element from the signature generator system 140, to receive a plurality of signatures (e.g., signature reduced clusters) of concepts matched to the multimedia content element from the deep content classification system 180, or both. In another embodiment, the decision provider 130 may be configured to generate the plurality of signatures, identify the plurality of signatures (e.g., by determining concepts associated with the signature reduced clusters matching the multimedia content element to be tagged), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

In an optional embodiment, the decision provider 130 may be configured to determine routes for trips to be taken by the vehicle between a beginning location and a destination location. The beginning location may be received (e.g., from a user via an interface of the driving control system 120), or may be determined based on a current location of the vehicle indicated by sensor signals obtained from the sensors 160 (e.g., a GPS signal captured by a GPS sensor installed in the vehicle). The destination location may be received via, e.g., the interface. In a further embodiment, the decision provider 130 may be configured to query one of the data sources 170 using a beginning location pointer and a destination location pointer, and to receive the determined route from the data source 170. The determined route includes a plurality of locations the vehicle will move to during the trip.

In an embodiment, the decision provider 130 is configured to obtain, in real-time, multimedia content elements from the driving control system 120 that are captured by the sensors 160 during the trip. At least some of the trip multimedia content elements demonstrate events. Each event may include the presence of one or more characteristics of the environment in proximity to the vehicle (e.g., within line of sight of the sensors, within a predetermined threshold distance, or both) that may require altering driving behavior such as, but not limited to, obstacles (e.g., pedestrians, animals, other vehicles, etc.), signs and other indicators of potential need for altering driving (e.g., signs indicating construction work, signs indicating school zones, exit signs, road signs etc.), traffic characteristics of a road (e.g., forks in the road, roundabouts, etc.), identifying characteristics of a road (e.g., a statue, building, or other item that can be utilized to uniquely identify the road), noises (e.g., sound of a jackhammer, animal noises, sounds of children playing, sirens, etc.), combinations thereof, and the like.

In an embodiment, the decision provider 130 may be further configured to obtain, from at least some of the sensors 160, sensor signals (e.g., GPS signals) indicating a geographic location of the vehicle in real-time during the trip and to determine, based on the geographic location sensor signals, current locations of the vehicle at various points during the trip. The geographic location at which multimedia content elements showing events were captured may be utilized to, e.g., uniquely identify the event, particularly when events showing similar features (e.g., two events showing construction materials in the road) require different driving decisions depending on location.

In an embodiment, based on the trip multimedia content elements, the decision provider 130 is configured to identify at least one matching event multimedia content element. In an embodiment, identifying the matching event multimedia content elements includes generating at least one signature for each trip multimedia content element and comparing the generated trip multimedia content signatures to signatures of the event multimedia content elements. In another embodiment, the decision provider 130 is configured to send the trip multimedia content elements to the SGS 140, to the deep content classification system 180, or both, and receiving the generated signatures, at least one concept matching the trip multimedia content elements, or both.

Each event multimedia content element is a previously captured multimedia content element demonstrating an event. The matching event multimedia content elements may be identified from among, e.g., event multimedia content elements stored in the database 150. In a further embodiment, the identified event multimedia content elements may only include event multimedia content elements associated with a current location of the vehicle (e.g., as determined based on the geographic location sensor signals) or event multimedia content elements associated with locations included in the determined route. Identifying only event multimedia content elements associated with locations related to the trip allows for uniquely identifying events and, consequently, corresponding driving decisions.

In an embodiment, the decision provider 130 is configured to determine at least one driving decision based on the identified event multimedia content elements. Each driving decision may include, but is not limited to, one or more instructions for controlling the vehicle to, e.g., avoid an accident due to events occurring during the trip. The driving decisions may be stored in the database 150, with each driving decision associated with one or more of the previously captured event multimedia content elements.

In an embodiment, the decision provider 130 is configured to cause, in real-time, implementation of the determined driving decisions. In a further embodiment, the decision provider 130 may be configured to send the determined driving decisions to the driving control system 120. In another embodiment, the decision provider may include the driving control system 120, and may be further configured to control the vehicle based on the determined driving decisions.

It should be noted that only one driving control system 120 and one application 125 are described herein above with reference to FIG. 1 merely for the sake of simplicity and without limitation on the disclosed embodiments. Multiple driving control system may provide multimedia content elements via multiple applications 125, and appropriate driving decisions may be provided to each driving control system, without departing from the scope of the disclosure.

It should be noted that any of the driving control system 120, the sensors 160, the decision provider 130, and the database 150 may be integrated without departing from the scope of the disclosure.

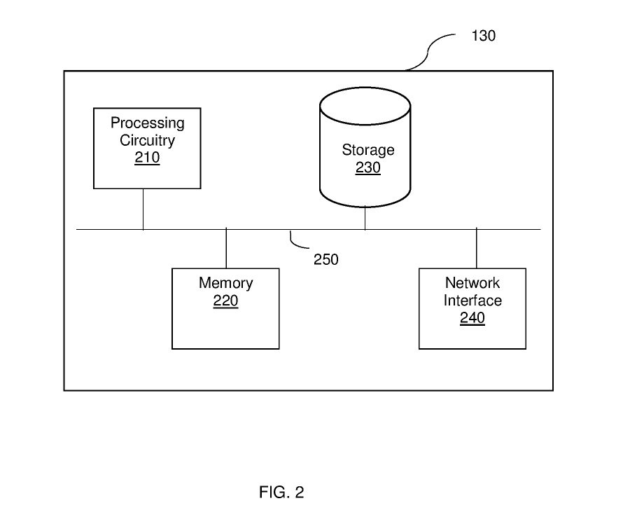

FIG. 2 is an example schematic diagram 200 of the decision provider 130 according to an embodiment. The decision provider 130 includes a processing circuitry 210 coupled to a memory 220, a storage 230, and a network interface 240. In an embodiment, the components of the decision provider 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 210 to perform the various processes described herein. Specifically, the instructions, when executed, cause the processing circuitry 210 to determine driving decisions based on multimedia content as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the decision provider 130 to communicate with the signature generator system 140 for the purpose of, for example, sending multimedia content elements, receiving signatures, and the like. Further, the network interface 240 allows the decision provider 130 to obtain multimedia content elements from, e.g., the driving control system 120, the data sources 170, or both.

It should be understood that the embodiments described herein are not limited to the specific architecture illustrated in FIG. 2, and other architectures may be equally used without departing from the scope of the disclosed embodiments. In particular, the decision provider 130 may further include a signature generator system configured to generate signatures as described herein without departing from the scope of the disclosed embodiments.

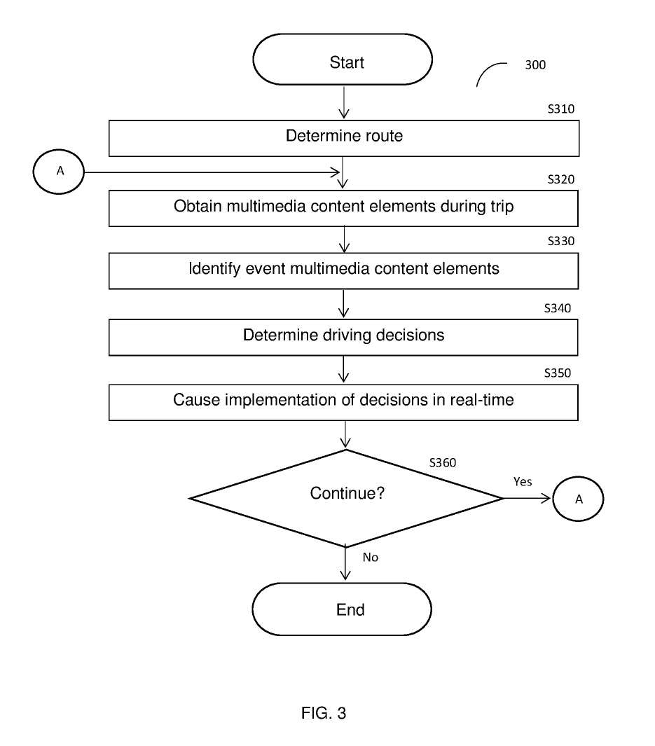

FIG. 3 depicts an example flowchart 300 illustrating a method for determining driving decisions based on multimedia content according to an embodiment. In an embodiment, the method may be performed by the decision provider 130 based on multimedia content elements captured by sensors (e.g., a camera) deployed in proximity to a vehicle such that the sensor signals indicate at least some features of the environment around the vehicle. The multimedia content elements may be captured during a trip, where the trip includes locomotion of the vehicle from a beginning location to a destination location.

At optional S310, a route may be determined. The route includes a plurality of locations between the beginning location and the destination location. In an embodiment, S310 includes obtaining a destination pointer indicating the destination location and a beginning location pointer indicating the beginning location. The beginning location pointer may be received (e.g., as user inputs), or may be a current location pointer represented by a global positioning system (GPS) signal received from a sensor deployed in proximity to the vehicle (e.g., a GPS system included in or affixed to the vehicle). The destination pointer may be, e.g., received as user inputs. As a non-limiting example, a driving control system of the vehicle may include an input/output interface for receiving user inputs related to destination. The determined route may be an optimal route, e.g., with respect to distance, typical traffic patterns, and the like.

In an embodiment, S310 may further include querying at least one data source for the route based on the current location pointer and the destination pointer. The queried data sources may include, but are not limited to, servers of web mapping services.

At S320, multimedia content elements are received during the trip. The trip multimedia content elements are captured by the sensors deployed in proximity to the vehicle, and may be, e.g., received from the sensors, from a driving control system communicatively connected to the sensors, and the like. The trip multimedia content elements are received in real-time, thereby allowing for providing automated or assisted driving decisions in real-time.

At least some of the trip multimedia content elements demonstrate events. Each event may include the presence of one or more characteristics of the environment in proximity to the vehicle (e.g., within line of sight of the sensors, within a predetermined threshold distance, or both) that may require altering driving behavior such as, but not limited to, obstacles, signs, characteristics of roads, noises, combinations thereof, and the like.

In an embodiment, S320 may also include obtaining sensor signals indicating a geographical location in which the trip multimedia content elements were captured. As a non-limiting example, S320 may include receiving GPS sensor signals indicating the current location of the vehicle as captured contemporaneously (e.g., at the same time or within a threshold time period) with the trip multimedia content elements. In some instances, the geographical location sensor signals may, in combination with the trip multimedia content elements, uniquely identify the event.

At S330, based on the trip multimedia content elements, at least one matching event multimedia content element is identified. Each event multimedia content element is a previously captured multimedia content element demonstrating a previously occurring event. For example, the matching event multimedia content elements may be identified from among a plurality of predetermined event multimedia content elements captured by sensors of other vehicles. Each event multimedia content element may be stored in, e.g., a database, and associated with a predetermined driving decision for altering driving behavior with respect to the event.

In an embodiment, S330 may include generating or causing generation of at least one signature for each trip multimedia content element and comparing the trip multimedia content element signatures to signatures of the plurality of event multimedia content elements. The event multimedia content element signatures may be previously generated, or S330 may include generating the event multimedia content element signatures. In an embodiment, each matching event multimedia content elements has a signature matching one of the trip multimedia content element signatures above a predetermined threshold.

In an embodiment, the matching event multimedia content elements only include event multimedia content elements associated with a current location of the vehicle (e.g., as determined based on the geographical location sensor signals obtained at S320), event multimedia content elements associated with locations included in the route determined at S310, or both. To this end, each previously captured event multimedia content element may be associated with an event location at which the event multimedia content element was captured.

Identifying event multimedia content elements associated with particular geographical locations may allow for uniquely identifying events, particularly when driving decisions for certain events differ. As a non-limiting example, the driving decisions for an event including the presence of construction crews or signs at a first geographic location (e.g., on a first street) may include shifting to a left lane, while driving decisions for an event including the presence of construction crews or signs at a second geographic location (e.g., on a second street) may include shifting to a right lane.

In an embodiment, S330 includes generating the signatures via a plurality of at least partially statistically independent computational cores, where the properties of each core are set independently of the properties of the other cores. In another embodiment, S330 includes sending the multimedia content element to a signature generator system, to a deep content classification system, or both, and receiving the plurality of signatures. The signature generator system includes a plurality of at least statistically independent computational cores as described further herein. The deep content classification system is configured to create concepts for a wide variety of multimedia content elements, automatically and in an unsupervised fashion.

In an embodiment, S330 includes querying a DCC system using the generated signatures to identify at least one concept matching the multimedia content elements. The metadata of the matching concept is used for correlation between a first signature and at least a second signature.

At S340, at least one driving decision is determined based on the identified event multimedia content elements. In an embodiment, each determined driving decision may be a predetermined driving decision associated with one of the identified event multimedia content elements. In a further embodiment, S340 may include obtaining the determined driving decisions. Each driving decision may include, but is not limited to, one or more instructions for controlling movement of a vehicle. As non-limiting examples, driving decisions may include, but are not limited to, a speed at which the vehicle should move, timing for decelerating or accelerating, directions for movement, distances for movement, timings for moving (e.g., timing for crossing a lane), a combination thereof, and the like.

Different driving decisions may be utilized for avoiding accidents with respect to different events. For example, a driving decision for controlling a vehicle in a school zone may include only reducing the vehicle's speed, while a driving decision for avoiding obstacles in the road may include moving around the obstacle or stopping the vehicle.

At S350, the determined driving decisions are caused to be implemented. In an embodiment, S350 may include sending the determined decisions to a driving control system of the vehicle. In another embodiment, S350 may include controlling the vehicle based on the determined driving decisions (e.g., if the driving control system is configured to determine the driving decisions).

At S360, it is determined if additional driving decisions should be provided and, if so, execution continues with S320. In an example implementation, execution may continue until the trip is completed by, for example, arriving at the destination location, the vehicle stopping at or near the destination location, and the like.

As a non-limiting example, a route is determined based on a destination point input by a user via an interface of a driving control system installed in a car. The car has mounted thereon a dashboard camera facing forward such that the dashboard camera captures video of the environment in front of the car. The route includes geographic locations on First Street, Second Street, and Third Street. The camera captures video showing the environment in front of the car during the trip. The captured trip video is obtained in real-time and analyzed to generate signatures therefore. The generated signatures are compared to signatures of event videos showing events occurring at locations on First Street, Second Street, and Third Street. Based on the comparison, a matching event video showing a pedestrian on First Street is identified. A driving decision associated with the matching event video is obtained. The driving decision includes instructions for stopping the vehicle. The driving control system executes the instructions, thereby stopping the vehicle.

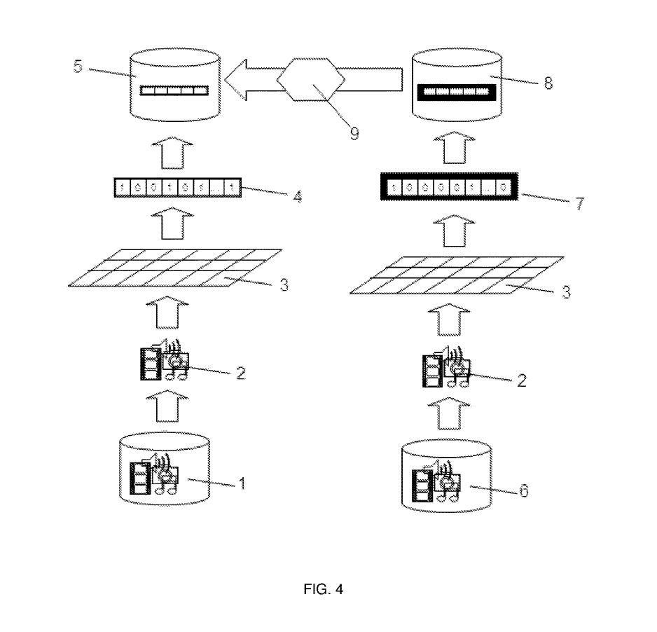

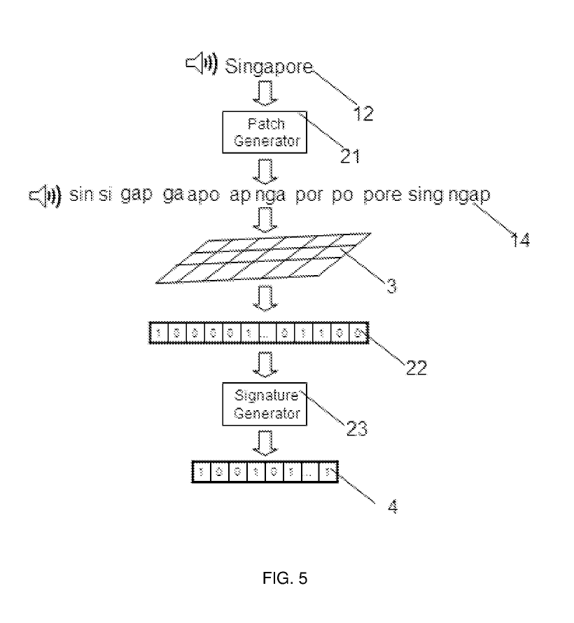

FIGS. 4 and 5 illustrate the generation of signatures for the multimedia content elements by the SGS 140 according to an embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame 1′ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={n}(1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( Vi - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Ths) and Robust Signature (ThRs) are set apart, after optimization, according to at least one or more of the following criteria:
1: For: Vᵢ≧Th_{RS}

1−p(V>Thₛ)−1−(1−ε)¹<<1

i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ≧Th_{RS})≈l/L
   i.e., approximately out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:
(a) The Cores should be designed so as to obtain maximal independence, i.e., the projection from a signal space should generate a maximal pair-wise distance between any two cores' projections into a high-dimensional space.
(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above.

It should be noted that various embodiments described herein are discussed with respect to autonomous driving decisions and systems merely for simplicity and without limitation on the disclosed embodiments. The embodiments disclosed herein are equally applicable to other assisted driving systems such as, for example, accident detection systems, lane change warning systems, and the like. In such example implementations, the automated driving decisions may be generated, e.g., only for specific driving events.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for determining driving decisions based on multimedia content elements, comprising:
obtaining, in real-time during a trip of a vehicle, trip multimedia content elements captured by at least one sensor deployed in proximity to the vehicle;
identifying, based on at least one signature generated for each trip multimedia content element, at least one matching event multimedia content element, wherein each event multimedia content element demonstrates an event and is associated with a corresponding driving decision; and
determining, in real-time, at least one driving decision, wherein each determined driving decision is associated with one of the identified at least one event multimedia content element.

2. The method of claim 1, wherein each identified event multimedia content element is associated with an event location, wherein the event location of each identified multimedia content element is a geographic location of the vehicle during the trip.

3. The method of claim 2, further comprising:
obtaining, in real-time during the trip, a plurality of global positioning system signals, each global positioning system signal indicating a current location of the vehicle at a different time during the trip; and
determining, based on the obtained global positioning system signals, a plurality of current locations of the vehicle during the trip, wherein the event location of each identified event multimedia content element is one of the current locations of the vehicle during the trip.

4. The method of claim 1, further comprising:
determining a route of the trip, wherein the route includes a plurality of route locations between a beginning location and a destination location, wherein each identified event multimedia content element is associated with one of the route locations.

5. The method of claim 4, wherein determining the route further comprises:
querying, using a beginning location pointer of the beginning location and a destination location pointer of the destination location, a data source; and
receiving, from the data source, the route.

6. The method of claim 1, further comprising:
sending, to a driving control system configured to control the vehicle, the at least one driving decision.

7. The method of claim 1, wherein each event includes at least one characteristic of at least a portion of an environment that is proximate to the vehicle.

8. The method of claim 1, wherein identifying the at least one matching event multimedia content element further comprises:
comparing at least one signature generated for each trip multimedia content element to a plurality of signatures generated for a plurality of previously captured event multimedia content elements, wherein each matching event multimedia content element is one of the previously captured event multimedia content elements having a signature matching a signature generated for one of the trip multimedia content elements above a predetermined threshold.

9. The method of claim 1, wherein each signature is generated by a signature generator system, wherein the signature generator system includes a plurality of at least partially statistically independent computational cores, wherein the properties of each core are set independently of the properties of each other core.

10. A non-transitory computer readable medium having stored thereon instructions for causing a processing circuitry to execute a process, the process comprising:
obtaining, during a trip of a vehicle, trip multimedia content elements captured by at least one sensor deployed in proximity to the vehicle;
identifying, based on at least one signature generated for each trip multimedia content element, at least one matching event multimedia content element, wherein each event multimedia content element demonstrates an event and is associated with a corresponding driving decision; and
determining, in real-time, at least one driving decision, wherein each determined driving decision is associated with one of the identified at least one event multimedia content element.

11. A system for determining driving decisions based on multimedia content elements, comprising:
a processing circuitry; and
a memory connected to the processing circuitry, the memory containing instructions that, when executed by the processing circuitry, configure the system to:
obtain, during a trip of a vehicle, trip multimedia content elements captured by at least one sensor deployed in proximity to the vehicle;
identify, based on at least one signature generated for each trip multimedia content element, at least one matching event multimedia content element, wherein each event multimedia content element demonstrates an event and is associated with a corresponding driving decision; and
determine, in real-time, at least one driving decision, wherein each determined driving decision is associated with one of the identified at least one event multimedia content element.

12. The system of claim 11, wherein each identified event multimedia content element is associated with an event location, wherein the event location of each identified multimedia content element is a geographic location of the vehicle during the trip.

13. The system of claim 12, wherein the system is further configured to:
obtain, in real-time during the trip, a plurality of global positioning system signals, each global positioning system signal indicating a current location of the vehicle at a different time during the trip; and
determine, based on the obtained global positioning system signals, a plurality of current locations of the vehicle during the trip, wherein the event location of each identified event multimedia content element is one of the current locations of the vehicle during the trip.

14. The system of claim 11, wherein the system is further configured to:
determine a route of the trip, wherein the route includes a plurality of route locations between a beginning location and a destination location, wherein each identified event multimedia content element is associated with one of the route locations.

15. The system of claim 14, wherein the system is further configured to:
query, using a beginning location pointer of the beginning location and a destination location pointer of the destination location, a data source; and
receive, from the data source, the route.

16. The system of claim 11, wherein the system is further configured to:
send, to a driving control system configured to control the vehicle, the at least one driving decision.

17. The system of claim 11, wherein each event includes at least one characteristic of at least a portion of an environment that is proximate to the vehicle.

18. The system of claim 11, wherein the system is further configured to:
compare at least one signature generated for each trip multimedia content element to a plurality of signatures generated for a plurality of previously captured event multimedia content elements, wherein each matching event multimedia content element is one of the previously captured event multimedia content elements having a signature matching a signature generated for one of the trip multimedia content elements above a predetermined threshold.

19. The system of claim 11, wherein each signature is generated by a signature generator system, wherein the signature generator system includes a plurality of at least partially statistically independent computational cores, wherein the properties of each core are set independently of the properties of each other core.

20. The system of claim 11, further comprising:
a signature generator system, wherein each signature is generated by the signature generator system, wherein the signature generator system includes a plurality of at least partially statistically independent computational cores, wherein the properties of each core are set independently of the properties of each other core.
